(19) United States
(12) Patent Application Publication
(10) Pub. No.: US 2026/0270081 A1
(43) Pub. Date: Sep. 10, 2026

(54) DIGITAL SIGNATURE ALGORITHM FOR VERIFICATION OF REDACTED DATA

(71) Applicant: nChain Licensing AG, Zug (CH)

(72) Inventor: Craig Steven WRIGHT, London (GB)

(21) Appl. No.: 19/166,452

(22) PCT Filed: Mar. 11, 2024
(86) PCT No.: PCT/EP2024/056368

§ 371 Date: Sep. 17, 2025

(30) Foreign Application Priority Data
Mar. 20, 2023 (GB) 2303996.9
Oct. 25, 2023 (GB) 2316299.3

(51) Int. Cl. H04L 9/32; G06F 21/62; H04L 9/06

(52) U.S. Cl. CPC H04L 9/3247; G06F 21/6254; H04L 9/0643

(57) ABSTRACT

Embodiments of the disclosure provide technical solutions for securing, sharing validating and/or generating data resources such as, but not limited to, documents. In an example embodiment, the document is expressed or defined as a plurality of constituent segments, which are then hashed. A Merkle tree is generated that represents the document, with the segment hashes as its leaves. An authorised signatory signs the root of the tree. A redacted version of the document can then be shared, omitting one or more segments that the data controller wishes to keep secret. In order to verify the authenticity and/or integrity of the redacted document, a validator is provided with sufficient data to check the existence of the non-segment(s) in the tree and also the authorised signature that signed the root.

### CROSS REFERENCE TO RELATED APPLICATIONS

This application is the U.S. National Stage of International Application No. PCT/EP2024/056368 filed on Mar. 11, 2024, which claims the benefit of United Kingdom Patent Application No. 2303996.9, filed on Mar. 20, 2023, and United Kingdom Patent Application No. 2316299.3, filed on Oct. 25, 2023, the contents of which are all incorporated herein by reference in their entireties.

### TECHNICAL FIELD

The present disclosure provides systems and methods for secure distribution of data, verification of data authenticity and integrity, and for preservation of data security. Additionally, or alternatively, embodiments provide improved digital signature algorithms for sharing, providing, storing, securing and/or processing of data resources. Embodiments utilise cryptographic techniques for enforcement of data security and access control, and are particularly suited for, but not limited to, use in redaction, anonymisation and/or sanitation of data that is to be shared with one or more parties.

Other technical effects include, but are not limited to, the ability to scale data storage solutions, provide secure and verifiable documents that are formatted for redaction (e.g. templates, forms etc that can be completed by user(s)) and the ability to represent hierarchies of data into verifiable storage resources without revealing or making available the contents themselves. Such solutions can be combined with blockchain technologies to further enhance validation of data integrity and authenticity.

These aspects are described and illustrated in more detail below.

### BACKGROUND

Throughout history, humans have found a need or desire to keep portions of shared information secret, revealing some parts but not others. In one simple, traditional approach, a document may be produced onto a surface such as paper and then the sensitive part(s) covered over or masked in some way, such as painting them over with dark ink or by placing a masking object such as tape or paper over the top.

Such techniques, however, are not easy to apply (especially in respect of lengthy documents) and can sometimes inadvertently reveal the sensitive content beneath. For example, if the ink is not dark enough to adequately obscure the underlying content or if the mask inadvertently moves during a subsequent copying or transfer process.

While computer-based technologies have provided numerous arrangements aimed at facilitating the redaction of electronic data resources, technical challenges still exist, especially in relation to large data sets. These include how to verify the authenticity and integrity of a shared data resource e.g. document even when one or more portions have been removed.

Therefore, there is a need to provide improved solutions for validating redacted electronic data resources. Such improved solutions have now been devised.

### SUMMARY

Any feature mentioned herein in respect of one or more aspects is not intended to be limited in that regard. Features disclosed herein may be used interchangeably with various embodiments and aspects.

According to one aspect, embodiments provide solutions for secure, cryptographically enforced access to or control of data that is to be transmitted or shared between a data controller and at least one data recipient. In particular, preferred embodiments may provide techniques and systems for redacting one or more portions of a data resource that is to be shared, processed or stored. ‘Redacting’ as used herein is intended to include obscuring, masking, removing, deleting and/or replacing one or more selected portions of a data resource.

In one form of wording, a preferred embodiment may involve using a Merkle tree to apply a signature algorithm to a data resource such that one or more segments (i.e. portions) of the data resource can be redacted without losing the ability to verify the authenticity or integrity of that data resource. Advantageously, embodiments may enable redaction of the selected portion(s) of the data resource without it impacting or negating the validity of a signature applied by the data controller to the data resource.

In such an embodiment, a data resource may be broken down into a plurality of segments. The size, number or other attributes of the segments can be determined based upon criteria selected by the data controller.

The segments may then be used to construct a tree structure that represents the data resource. Preferably, the tree structure is a hash tree (also known as a Merkle tree) in which leaf nodes at the bottom of the tree are hashed in pairs to provide a hash that serves as parent node in the previous (i.e. immediately higher) level of the tree. This hashing of pairs continues until a hash is computed for the root of the tree.

After the segments of data from the data resource have been hashed to form a Merkle tree, the data controller(s) may cryptographically sign the root has so as to testify (attest) to the authenticity and/or integrity of the data contained within/represented by the tree. The signature(s) provide evidence that the data resource has been authorised, created and/or processed by the data controller.

The data controller may then select one or more segments that are to be redacted from the data resource prior to storing, processing, accessing and/or sharing the data resource.

Redacting the selected segment(s) may comprise one or more of obscuring, altering, masking, removing or replacing the original versions of the selected segments from the data resource (or a copy thereof).

The data controller can share or present one or more of the following with one or more recipients:
Merkle tree of the entire, original (pre-redaction) data resource;
Public key(s) corresponding to the private key(s) that were used to sign the root hash, to facilitate verification of the signature;
the non-redacted segments of the data resource.

The recipient(s) can use the public key(s) to verify that the data resource represented in the Merkle tree has, indeed, been generated and/or authorised by the data controller(s) that own the corresponding private keys.

Thus, verification may be performed by a verifier by: constructing the tree that represents the un-redacted version of the data resource;
checking that the root of the constructed tree matches the root of tree that the data controller has shared; and/or
checking that the signature applied to the signed Merkle root provided by the data controller has been generated/authorised by the data controller.

Construction of the tree that represents the un-redacted version of the data resource can be performed by the verifier using the redacted version of the data resource plus the hashes of the redacted segment(s). Thus, verification can be performed by the verifier upon the signed Merkle root of the constructed instance of the Merkle tree that represents the unredacted, original version of the data resource.

In some embodiments, the data controller(s) may retain the redacted segments (e.g. in encrypted form). Additionally, or alternatively, the data controller(s) may destroy/delete their original copy of one or more redacted segments.

In accordance with one or more aspects, the disclosure may provide computer-implemented apparatus (e.g. stand-alone devices or systems) that facilitates one or more of the steps indicated above. The apparatus may comprise hardware, software and/or firmware for the performance of one or more of the method steps disclosed herein.

In one embodiment, the apparatus may comprise software, firmware and/or hardware arranged to facilitate or enable one or more of:
decomposing the data resource into the plurality of segments;
generating a Merkle tree that represents the plurality of segments;
cryptographically signing the root hash of the tree;
selecting one or more segments for redaction from the data resource or a copy thereof;
sharing, storing or otherwise processing the signed hash root, the Merkle tree of the data resource, the original data resource and/or the original segments selected for redaction.

In another embodiment, the apparatus may comprise software and/or hardware arranged to facilitate or enable display, reproduction or presentation of the redacted data resource by a recipient. Such apparatus may comprise a browser, wallet, word processing software or any other software application that is operative to process (e.g. display, print, audibly reproduce etc) the data resource minus the selected, redacted segments.

In some cases, this could be by simply providing a predetermined flag (e.g. audible sound, visual symbol(s), tactile vibration or other signal) that indicates that a portion of the data has been redacted at that location within the data resource. In this sense, the flag may replace the redacted segment(s) in the redacted version of the data resource upon reproduction by the recipient(s).

In contrast to prior art approaches which provide selective disclosure techniques involving the provision of Merkle proofs (paths) to a particular piece of data, embodiments of the disclosure involve signing the root of the tree for the entire data resource. After signing, a verifying party can check that the entire document is legitimate, authentic and unaltered despite having been provided with a redacted version of the original data resource.

Additional technical effects include, but are not limited to, the ability to scale data storage solutions, provide secured and verifiable documents that are formatted for redaction (e.g. templates, forms etc that can be completed by user(s)) and the ability to represent hierarchies of data into verifiable storage resources without revealing or making available the contents themselves.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 shows an example embodiment of the disclosure, in which a data resource, which in our example is a document, is created and divided into a plurality of segments.

FIG. 6 shows an example embodiment of the disclosure, in which the segments of FIG. 5 are hashed and used to construct a Merkle tree that represents the plurality of segments.

FIG. 7 shows an example embodiment of the disclosure, in which a Merkle tree root is signed using suitable Digital Signature Algorithm such as, but not limited to, ECDSA.

FIG. 8 shows an example embodiment of the disclosure, in which the required data is provided to a validating part, such as Bob, so that he can calculate the rest of the data himself and then check that the signed Merkle root he has been given matches what he has calculated himself.

FIG. 9 shows an example embodiment of the disclosure, in which the validator uses the data provided in FIG. 5 to perform the validation process.

FIG. 10 shows an example embodiment of the disclosure, in a Merkle tree is used to verify larger segments of the same file or a singular copy of the whole file as individual segments.

FIGS. 11 and 12 show example embodiments of the disclosure, in which a Merkle path is provided for optimisation of customised documents e.g. contracts.

FIGS. 13 to 26 provide illustrations and examples of various embodiments in use, and how the disclosure can be put into effect in an example file system which is, in our example a VAST file system. In particular:

FIGS. 13 and 14 provide illustrations of how a data controller e.g. database administrator can create and add to a VAST file system using embodiments disclosed herein.

FIG. 15 shows an example of the embodiments of FIGS. 13 and 14, in which a user generates the VAST file system records and attributes ownership of the file system to an identity.

FIGS. 16 to 18 provide illustrations of how a user can request and receive a file from the VAST file system illustrated in FIGS. 13, 14 and 15.

FIG. 19 illustrates how a user can validate the files requested and obtained from a VAST file system implemented in accordance with an embodiment of the disclosure, and illustrated in FIGS. 13 to 18.

FIG. 20 illustrates how an entry in the example use case of FIGS. 13 to 19 can be altered once or multiple times.

FIG. 21 illustrates how embodiments can be used to perform scalable updates of information and data such as the data recorded and processed in the illustrative system provided herein.

FIG. 22 illustrates how sub-tress can be used within the Merkle tree of various embodiments disclosed herein.

FIGS. 23 to 26 illustrate how the sub-trees of FIG. 22 can be put into effect, and how the example system provided herein can be used to create sub-trees of larger trees so as to represent more complex, hierarchical redactable documents in accordance with various embodiments of the disclosure.

### DETAILED DESCRIPTION OF EMBODIMENTS—INVENTION SPECIFIC MATERIAL

We now provide, for the purpose of illustration, examples of preferred embodiments of the disclosure.

In accordance with preferred embodiments, the disclosure provides methods and corresponding systems for the redaction of one or more portions of data from a data resource, which we will hereafter refer to as a document simply for illustration purposes and ease of reference.

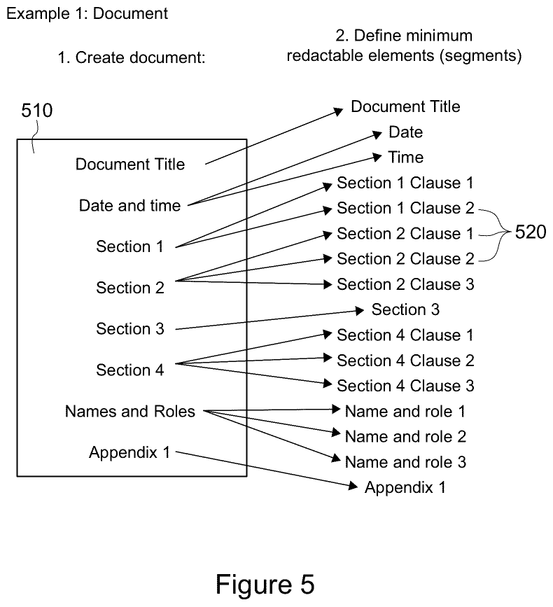

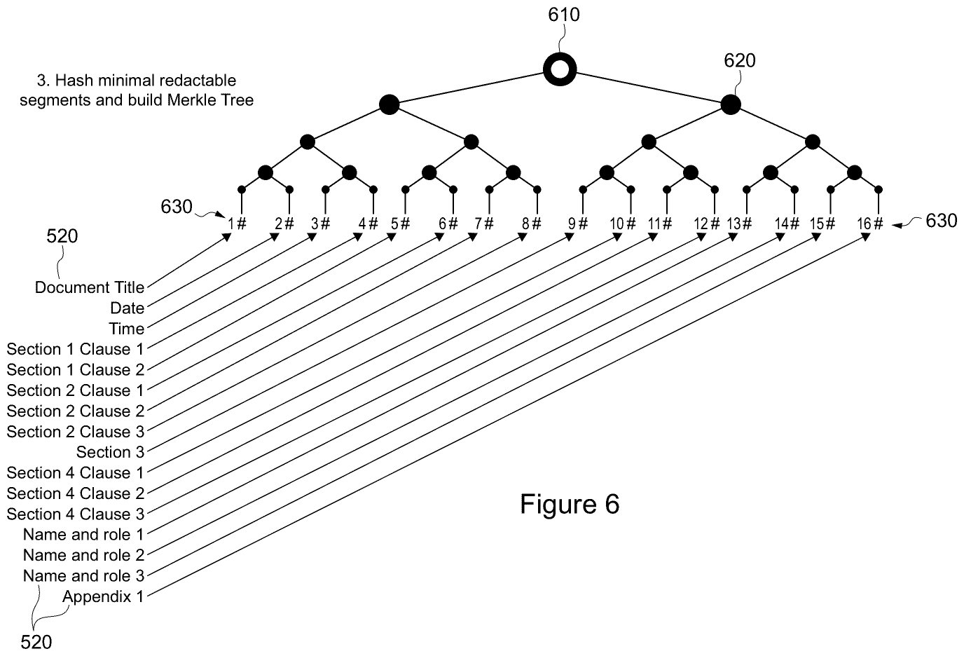

Embodiments of the disclosure provide solutions (methods and systems) for secure and verifiable redaction of data resources 510, scaling of systems for data storage and/or verification, and improved systems for storage hierarchical data on computer-based storage resources. Referring to FIGS. 5 and 6, at least one data resource 510 is decomposed into a plurality of segments 520 that are then represented in a tree structure that has a root 610. The root 610 is then signed by an authorised party in order to attest to the authenticity of the data contained in the tree. For ease of reference, we may refer to the authorised party as a controller of the data resource. The signature can then be used by another party to verify the legitimacy of the document 510, even though one or more portions of it 520 have been redacted from the version that has been provided to that party. Advantageously, the disclosed techniques do not damage or reduce the integrity of digital signatures applied to the totality of the document's contents.

A document 510 can be created and then split into smaller elements (segments) 520. The segments can be as small as the smallest divisible unit (e.g. single characters) or comprise larger portions of data. In some cases, a segment could be an entire file or group of files. In other words, a segment is a portion, logical or otherwise, of a data entity/resource.

A tree is created that often has inner nodes 620 and uses hashes of the segments 520 as the leaves 630 in the tree. In a preferred embodiment the tree is a Merkle tree, which is the term we will refer to hereafter for ease of reference.

In order to authorise the document 510 and attest to its origin, authenticity and/or integrity, one or more data controllers sign the Merkle Tree root 610. The signature may be generated using a cryptographic key, and may be referred to as a digital signature or a cryptographic signature. Advantageously, the signature is applied to the Merkle Tree Root that comprises the document, rather than on the document itself. In a preferred embodiment, the individual hashes 630 are not signed.

In some examples, the data controller may be the creator of the document, or a representative, or some other party that has legitimate or authorised control of the document. In some cases, ‘control’ may include ‘ownership’ of the document. The validator (which may also be referred to as ‘the verifier’) can calculate the root and check the signature if the validating party is provided with the necessary minimum data from (or on behalf of) the data controller.

In the following examples, we will refer to the data controller as Alice, and the other (validating) party as Bob. Bob may also be an end user/consumer that uses or views the redacted version of the document, or in some cases Bob simply performs the validation process and then, once assured of its legitimacy, passes the redacted data resource to the end user. In more detail, a preferred embodiment may comprise at least one or more of the following steps. One or more of the steps listed below can be provided by a single party or group of parties, or by a plurality of separate parties. The process may be distributed.

### Step 1

With reference to FIG. 5, Alice creates her document 510 and then breaks it up into a plurality of segments 520. This may comprise generating a logical definition of the segments rather than a physical breaking up of the data. How Alice decides to decompose the document is an implementation choice. The decomposition may be based on or determined using criteria that Alice has selected or obtained, such as the size, number or other segment attribute(s). For example, she may decide to break the document up into the smallest divisible unit such as individual bits, or individual (e.g. ASCII) characters, or single/multiple byte segments, or in accordance with any other any other criteria that Alice chooses.

The segments can comprise any part of the document from a single character up to whole sections or chapters. By dividing the document up into small segments, Alice is able to have a granular level of control over which parts of the document she wishes to redact.

### Step 2

With reference to FIG. 6, Alice hashes the individual segments 520 and uses them to represent the document 510 a in a tree structure. Alice inserts the hash 630 of each segment 520 in the Merkle tree as a leaf node 630 (which may also be called a leaf element, or simply ‘leaf’).

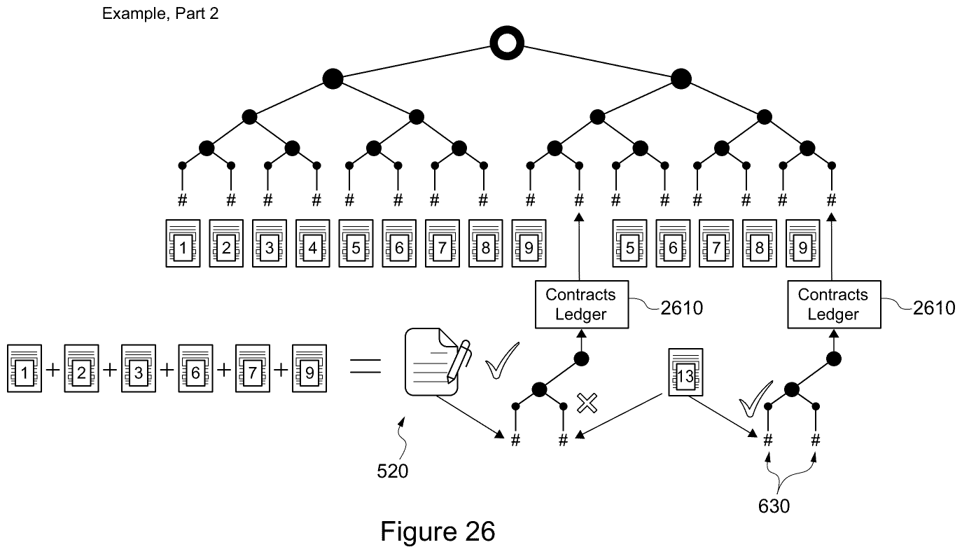

Although a segment 520 may be able to be decomposed further into sub-segments 2610 (seen in FIG. 26, for example), segments 630 are the smallest individual redactable components of a document. In other words, once the Merkle tree is constructed using segments as its leaves in steps 2 and 3, it is not possible to redact any smaller part of the document 510 than a segment 630. Therefore, a segment may also be referred to as a ‘minimum redactable element’ 630.

AS seen from the illustration of FIG. 6, the order, and structure of the segments, and the relationship between them, is preserved and represented in the Merkle tree. This can be important for subsequent use of the processed data, such as reassembling the segments in a viewable/usable form so that the user can read or otherwise process the redacted version of the document. In other embodiments, however, the original order or structure of the segments may not need to be preserved, or may be deliberately randomised when the tree is constructed, depending on the requirements of the implementation and use case involved.

### Step 4

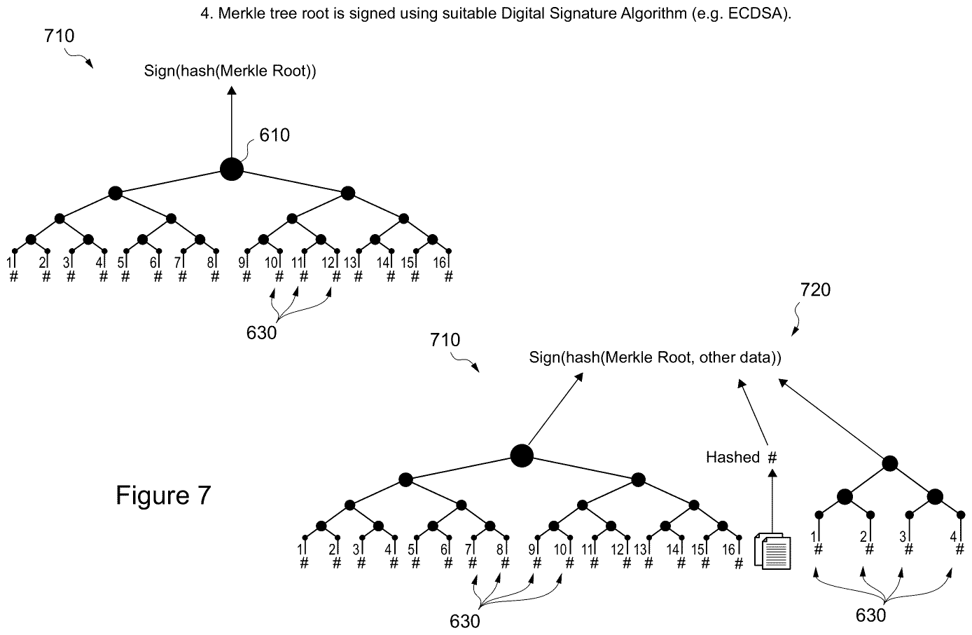

With reference to FIG. 7, Alice signs the hash at the top of the tree (i.e. the root) . The signature 710 may be generated using the following:
1. The signing party's private key (e.g. Alice's private key), which is associated with a public key
2. K-Value—this is usually a random value
3. A message hash Advantageously, the hashed message may include other data elements 720. These can be hashes of other documents or data items, or other Merkle tree roots, allowing a single signature to be applied across multiple documents.

### Step 5

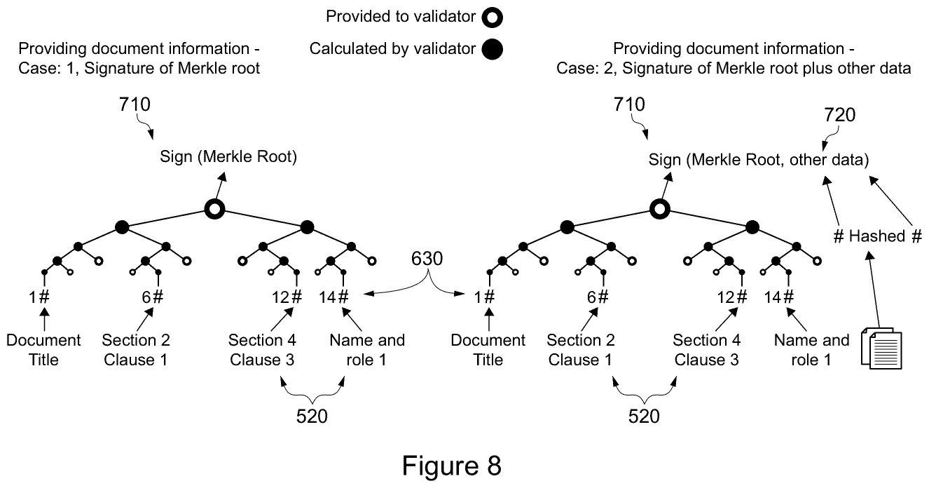

With reference to FIG. 8, Alice redacts at least one segment from the document by choosing one or more segments to omit from the version of the document that will be provided to Bob. This could comprise the step of choosing at least one segment that will only be provided in hashed form, not the original, preimage version.

### Step 6

With reference to FIG. 8, Alice provides the tree root 610, the non-redacted segments plus the hashes of any redacted segments that Bob will need for verification.

In other words, Alice provides the non-secret parts of the document that she is willing to share with Bob plus the data that he needs in order to perform the validation process because he cannot calculate that data for himself.

In cases where Bob is both the validator and the end user that will consume (i.e. use, store or otherwise process) the redacted data, Alice may provide all non-redacted segments to Bob. Alternatively, Bob may simply be performing a validation function, and not be the end consumer. In such cases, Alice may choose to provide Bob with a sample of non-redacted segments purely for validation purposes, rather than all of them.

In the simple case, case 1, as shown in FIG. 8, document information provided to the validating party i.e. Bob, may comprise.
the Digital Signature
the Merkle root
At least one non-redacted document section
Merkle paths to the non-redacted document sections that are being provided In the more complex case, case 2, additional data item(s) may be provided by Alice in the signed message along with the signed Merkle root as mentioned above.

As also shown in FIG. 8, in such cases Alice provides Bob with:
her digital Signature
the Merkle root
other hashes for the additional data (e.g. metadata) in the signature message. The entire preimage(s) must be made available to Bob so he can calculate the hash(es) and perform the necessary check(s)
at least one non-redacted document section
Merkle paths to the non-redacted document sections that are being provided to Bob

It can be seen from FIG. 8 that Alice does not need to send the entire Merkle tree to Bob. Alice simply needs to provide Bob with the non-redacted portion(s) of the document that she is going to share, plus any data that he needs to be able to confirm the signature that has been applied to the signed data. The signed message 710 could comprise just the Merkle root (case 1) or the Merkle root plus the additional data 720 (case 2).

### Step 7

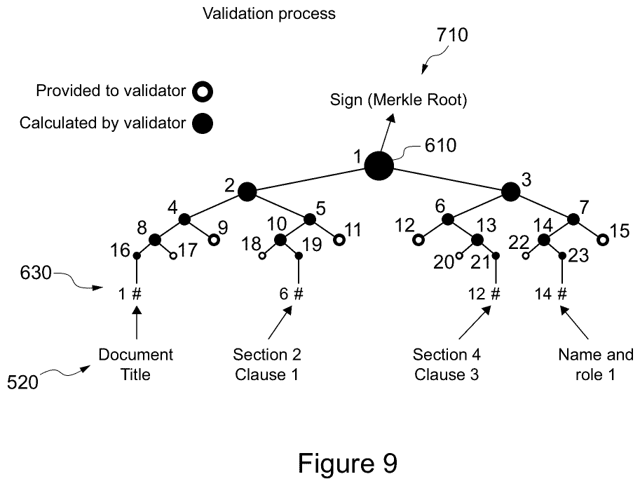

With reference to FIG. 9, Bob verifies the authenticity/integrity of the document even though one or more segments of it have been redacted. The validation process can comprise at least the following steps, in which Bob:
1. checks that key/digital signature/message match
2. checks that the Merkle root matches the version provided in the message
3. accesses one minimal redactable segment 630
4. hashes the minimal redactable element
   a. uses the provided Merkle path elements to calculate the root
   b. hashes of non-redacted document sections
   c. Merkle paths to non-redacted document sections (i.e. the smallest number of additional nodes in the tree required to compute the root hash, starting from a given leaf).

In the example of FIG. 9, Bob performs the validation process by carrying out the following calculations:
1. Hash document title to generate ‘16’
2. Hash 16 and 17 to calculate 8 (this comprises concatenating 16 and 17 and hashing the result)
3. Hash 8 and 9 to calculate 4
4. Hash Section 2 Clause 1 to calculate 19
5. Hash 18 and 19 to calculate 10
6. Hash 10 and 11 to calculate 5
7. Hash 4 and 5 to calculate 2
8. Hash Section 4 Clause 3 to calculate 21
9. Hash 20 and 21 to calculate 13
10. Hash 12 and 13 to calculate 6
11. Hash ‘Name and role 1’ to calculate 23
12. Hash 22 and 23 to calculate 14
13. Hash 14 and 15 to calculate 7
14. Hash 6 and 7 to calculate 3
15. Hash 2 and 3 to calculate 1 (. i.e. the root).

It should be noted that Bob does not need the entire Merkle tree or all hashes of the redacted segment(s). Once the Merkle Root has been calculated (step 15) it can be checked against the value of the hash used to generate the signature to see if it matches what Alice provided him with. If the hash matches and the signature is valid, the redacted segments are proven to form part of the overall document, and that the signature has been applied to the totality of the items in the leaves on the tree. In other words, Bob can prove that Alice used her secret, private key to generate the signature applied to the root of the Merkle tree that represents the entire, unredacted document.

### Step 8

The redacted document can be provided e.g. displayed or outputted in some way by the end user/consumer (which, as explained above may be Bob or at least one other party. We will assume here that it is Bob for the sake of convenience.

In some cases, Bob may use a browser, wallet, Word processor, image display application, or other software application that is arranged to output or otherwise process the non-redacted data. The output of the non-redacted data may be provided in a visual, audible or tactile form, or in electronic form such as a digital resource that can be stored or otherwise processed. For example, a sound or video file may be played, or a document may be displayed on screen or printed to an output device of some type, or at least one data file may be outputted which is then stored and/or transmitted to at least one recipient.

In some embodiments, one or more of the redacted segments may be replaced by an alternative marker or indicator. For example, a redacted portion of a text file may be shown on screen with a blank box or ‘X’ etc in the place of the redacted data. In the case of audio files, a bleep or other indicative sound may be played. This allows the viewer/listener/end user to know that a portion of data has been removed at that location in the data.

### VARIATIONS AND USE CASES

### Secure, Distributed Storage Techniques

In some embodiments, Alice may retain the redacted segment(s). Additionally, or alternatively, she may destroy/delete the original copy of one or more redacted segments. In some examples, redacted segments could be sent to different storage facilities for safe keeping. One or more segments could be encrypted using different algorithms and/or keys. Advantageously, someone wanting to reproduce the whole document would have to gain access to individual, redacted segments from different (preferably secret) locations and know the multiple encryption algorithms and keys that were used. This may make access to the complete document much harder, providing a more secure data storage solution that is less vulnerable to unauthorised access. Highly sensitive, personal, commercially valuable or security-related data may benefit from storage using such an approach.

### Large Data Resources

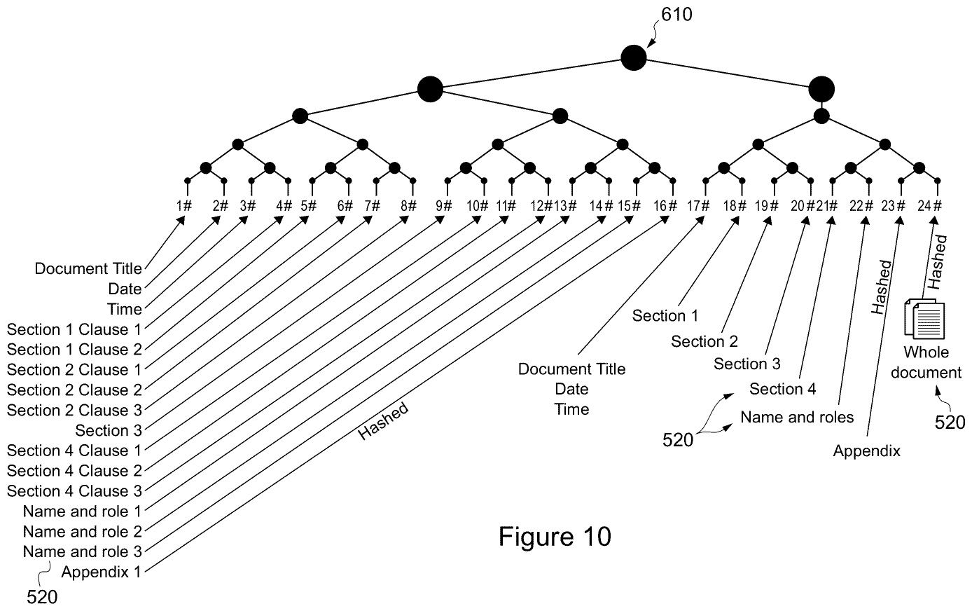

Larger In FIG. 10, it can be seen that the use of the Merkle tree can be extended to include larger segments of the same file or a singular copy of the whole file as individual elements. For large items with many minimum redactable segments, this can make sharing the document more efficient as fewer Merkle paths and less data needs to be provided by Alice to Bob in order to share larger non-redacted sections. None of the properties are impacted, except that the quantity of Merkle path data that must be shared per segment may increase by a small amount.

### Templates and Forms

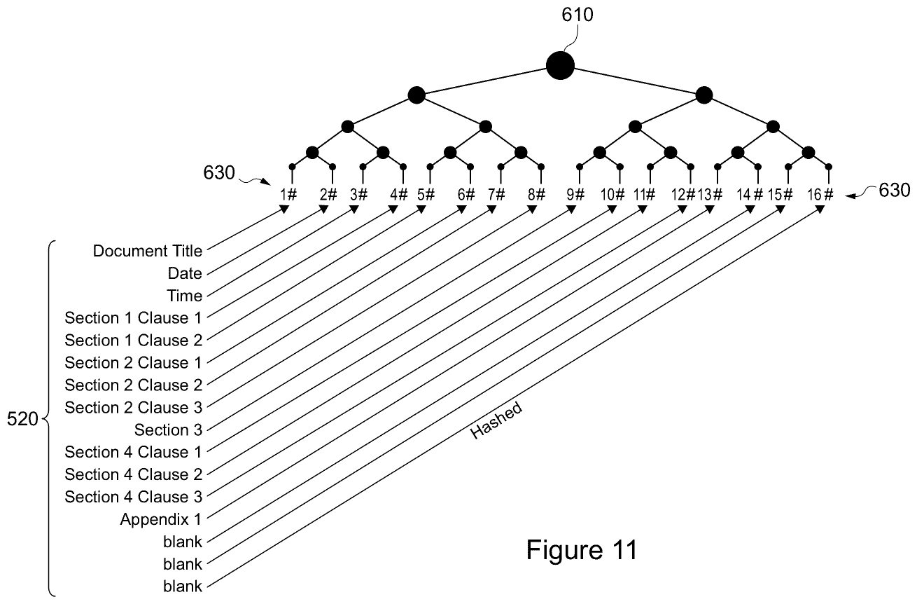

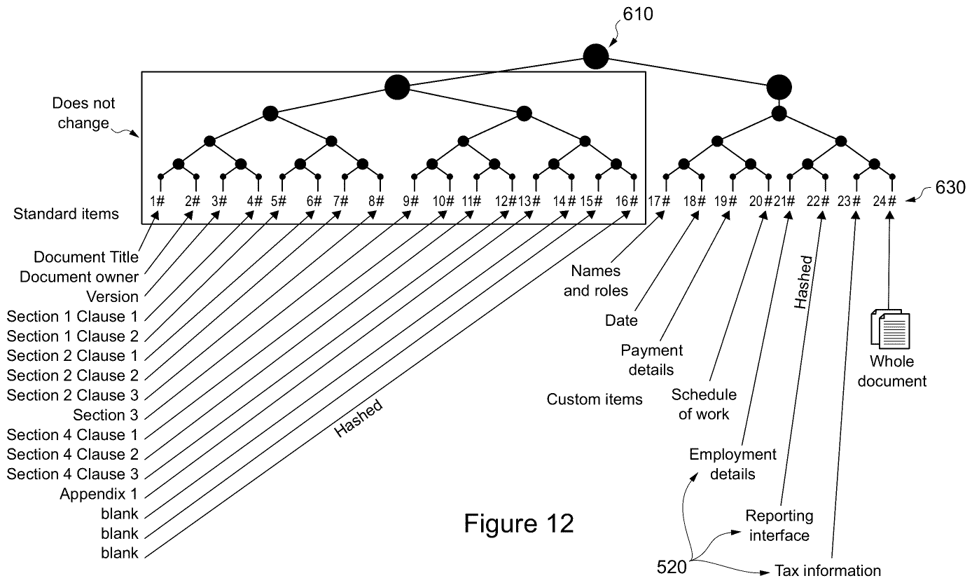

With reference to FIGS. 11 and 12, a Merkle path can be used for optimisation of customised documents. In such cases, the redacted segments can be used as ‘empty’ sections of the document that the user can complete. For example, the document could be a contract, a form, a template, a payment authorisation or any other type of document that needs to be completed, executed, adapted or altered by a user in some way. For convenience, we will use the widely known example of contracts.

For a contract that will be re-used on different occasions by different contracting parties, the contract can be broken down into sections and a Merkle tree formed with 2\hat{ }N leaves as shown in FIG. 11. Where the contract has fewer than 2\hat{ }N segments, it can be padded using blank leaves as illustrated in FIGS. 11 and 12. This Merkle Branch can be re-used many times to create separate, individual contracts which each use the same template agreement. In this way, the contract creator e.g. Alice can add individualised sections to the contract in a separate branch without having to modify any of the hashes in the template branch.

As shown in FIG. 12, when a copy of the document is signed, names, roles and any special conditions etc can be added to the Merkle tree without changing the hashes of any of the already existing branch of the tree. In the example of FIG. 12, a pro-forma employment document is created with a set of standard sections and clauses. Anyone with the same contract can use the same Merkle path to validate the static (non-redacted) sections of their document against the template, but any customised sections supplied by the user will have different hashes, a different Merkle path and generate a unique Merkle root.

Therefore, in accordance with one or more embodiments, improved solutions for obtaining or providing forms, templates or other types of data resources that necessitate or facilitate completion by one or more users. The act of completion may comprise contribution of at least one signature (digital, cryptographic or otherwise formed) and/or the contribution of one or more pieces of data. A redacted version of the data resource may be formed in accordance with any embodiments disclosed herein, and provided to one or more users.

The user(s) may contribute a response or input to replace, supply, alter, modify or otherwise process the at least one redacted segment(s).

In this way, the redacted segment(s) may function as placeholder(s) for input that is to be provided by the one or more users.

In some embodiments, the user may complete the redacted version of the document (i.e. template) by filling in the missing data and the completed version of the template may then be verified, either by the previous verifier (Bob) or another party.

For example, consider a scenario wherein an data controller e.g. organisation such as passport office, a company that employs one or more individuals, an airline etc. wants to send a form to a user for the user to complete. The user could be, in these examples, a passport applicant, an employee, a passenger etc. We will use the example of a passport office and passport applicant for illustration.

The passport office has a standard form that applicants are required to fill out. The form can be provided in a variety of formats, e.g. including for applicants who are deaf, blind etc. The form comprises segments of data that need to be outputted to the applicant via screen, paper, vibration, sound etc. It also includes segments that are left blank, that the applicant needs to complete by inputting some data at that location within the document.

However, suppose that it is known or suspected that unauthorised entities are distributing illegitimate versions of the form to potential victims of fraud, posing as the passport office and seeking completion of their faked form in order to gain valuable personal data, financial data and/or accompanying payment.

In such situations, the passport office may provide a hardware and/or software-based verification component that can be used by applicants and/or the passport office to verify the authenticity of the form that the applicant has provided. This verification component may be provided in a variety of forms, such as via an internet-based resource such as a web site or a cloud-based facility, or an installable app, and/or a digital wallet, or any other type of computer-based arrangement.

The passport office can, when providing their legitimate version of their application form, redact one or more segments of their form for completion by the applicant(s). It may also insert a hidden code, watermark, verification identifier, timestamp etc. in one or more of the non-redacted segments. This could be performed using any suitable, known manner that facilitates watermarking such as, for example, the use of steganography. Essentially, one or more of the segments could be arranged such that it comprises a (preferably) hidden identifier or code that can be checked using the verification process described herein. The identifier/code/watermark/timestamp/reference etc may be selected so as to uniquely identify an event, a party associated with the data resource, at least one blockchain transaction, a version number and/or data, a cryptographic key or any other type or form of data that the data controller wishes to include into the data resource. We will use the phase ‘identifier’ to include code/watermark/timestamp/reference etc. The identifier may be obtained using at least one random or pseudo-random operation, or as the result of a mathematical operation, but by selection/generation by one or more human individuals or processor-based means.

In cases where the identifier relates to a blockchain transaction, the identifier may comprise or provide a transaction ID, a block ID, the transaction/block itself or part thereof, and/or a hash of any of these. The transaction(s) may comprise data relating to the data resource and/or data controller. In other cases, alternative storage locations for this related data may be used e.g. the cloud, a web site, a server etc., although storage in the blockchain has the benefit of providing an immutable, timestamped and cryptographically secured copy of the data.

In some cases, the verification identifier could be provided in one or more redacted segments, as verification proves that the redacted segments are part of the entire, original document via the use of the signed Merkle root. This provides the advantage that while the data controller is able to verify the copy that is returned to them, an unauthorised party is not able to forge the verification identifier because it was not included within the shared, redacted version that the user receives. In this way, embodiments can provide security measures that allow users to verify, with a data controller, if the data resource they have received is indeed legitimate and/or up to date.

The Merkle tree root may be digitally signed by the passport office as described above and the selected, non-redacted segments made available to the end user as previously explained. When an applicant submits a form to the passport office via an authorised route, the form (or the signed Merkle root for that form) that they have completed can be appended to, or provided along with the user's completed data. This allows the application form that the user has used to be verified in accordance with an embodiment disclosed herein. If the form that the user submits to the passport office has been modified in any way compared to the authorised version, the hashes and signatures will not match the legitimate ones. Accordingly, the passport office can notify or alert applicants who submit forms to the passport office via electronic means such as completing an online form or downloading an authorised ‘application submission’ app, as to the validity or otherwise of their submitted data. Applicants can receive a verification notification to indicate that their received and completed form was checked at the passport office and has been verified as being legitimate or otherwise.

Similarly, the segment(s) may comprise a version number for the form. If the law changes the version number of the legitimate passport forms are updated. If the user completes a legitimate but outdated version of the application form, the verification software can be arranged to identify this and send an alert and/or reject the application.

Therefore, embodiments can provide methods and systems that not only provide verifiable forms and templates etc for user completion, but also provide security methods and systems for checking that, when such a form is received by a data controller, it has not been modified, corrupted or fraudulently supplied. It can also provide versioning solutions for shared data including documents, digital content, executable code etc.

### Use Case Examples: VAST File System and Database Snapshot

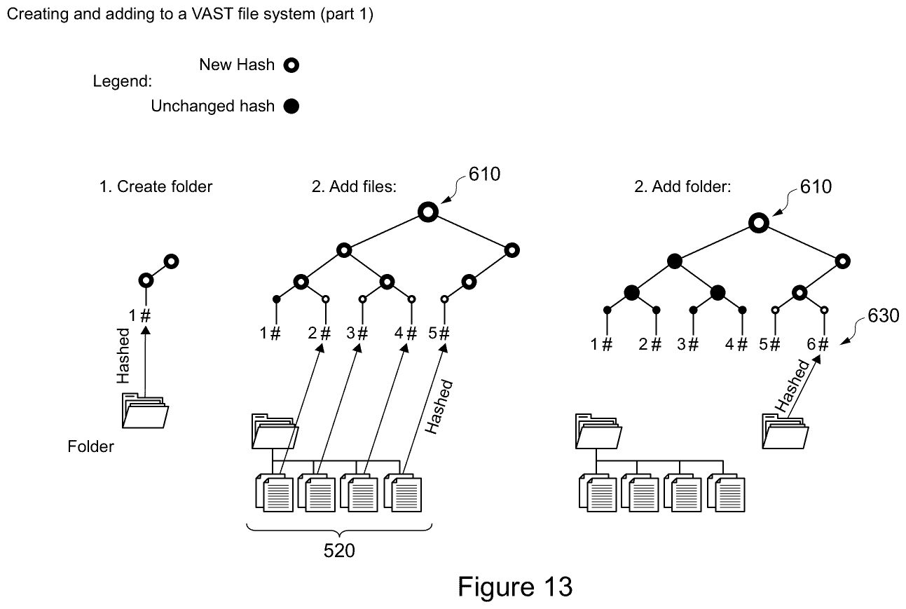

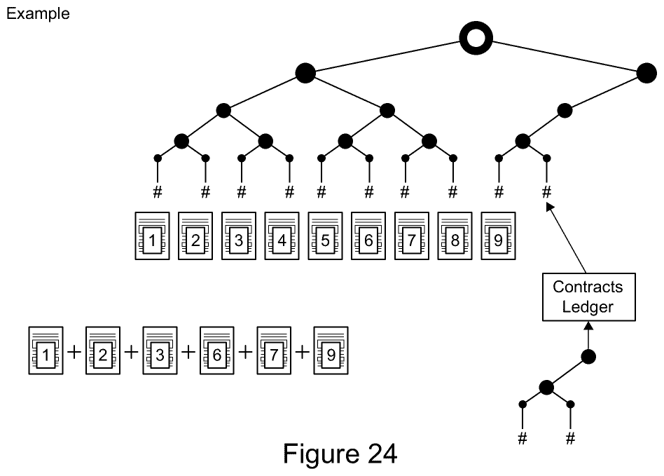

For the purpose of illustration, we now provide an example use case of how an embodiment of the disclosure can be put into effect, with particular reference to FIGS. 13 to 24. Files can be considered as segments. Files can be added or changed within the system.

For our example, consider a scenario in which an item is created (recorded) in a database. A file is created on one or more memory modules in one or more locations, and the file system can be accessed in one or a plurality of devices or accessed from one or a plurality of locations. A VAST file system is a file system comprised of files stored in a multitude of places. Using techniques disclosed herein, the file system is represented in a Merkle tree that includes each file as a leaf of the Merkle tree and may include information such as routing data and database memory location to facilitate file accessibility.

A leaf in the Merkle tree may also be the root of another Merkle tree which represents a file that is redactable in accordance with one or more methods disclosed herein.

One or more signatures are generated by data controller(s) and applied to the VAST file system's Merkle root and thus to the total contents of the database. Therefore, this provides a secure and verifiable snapshot of the filesystem at the moment that the signature was generated. Any file can be proven to have been part of the vast file system if the file and the Merkle root to the file's leaf are available. If the file is in redactable format, the Merkle path to the file's Merkle root, and the Merkle path to the non-redacted file segments that are being shared must both be provided to the receiver to show that 1) the file or redactable element of the file being provided are correct and also 2) that the file was accepted into the VAST file system.

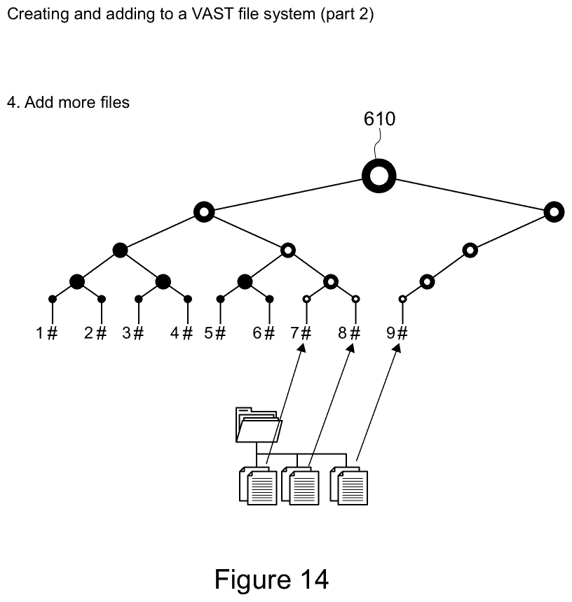

FIGS. 13 and 14 provide illustrations of how a data controller (e.g. database administrator, Alice) can create and add to a VAST file system using embodiments disclosed herein. As FIG. 13 shows, each entry/item has a unique location in the Merkle tree.

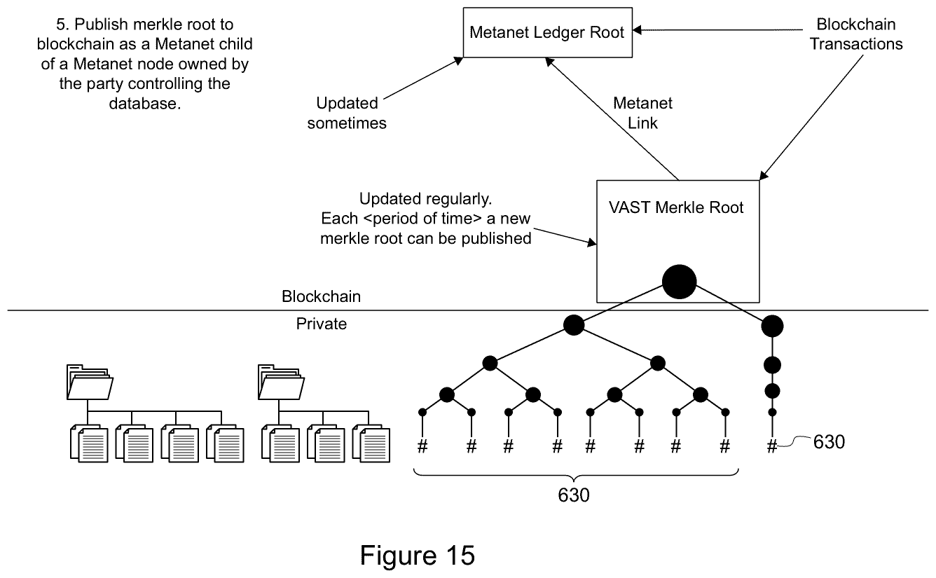

FIG. 15 shows a process in which Alice generates the VAST file system record and attributes or assigns ownership of the file system to an identity such as an owner, organisation, department etc. As shown in FIG. 15, Alice can publish the Merkle root to a blockchain. This could be, in some examples, a public blockchain such as, but not limited to, the Bitcoin blockchain. Additionally, or alternatively, Alice can publish the Merkle root to the public as a Metanet child of a Metanet node owned by the party controlling the database (substantially as in accordance with one or more of: WO2020/109910, WO2020/110025, WO2021/229334, WO2022/200193, WO2020/109908, which are incorporated herein in their entirety). Advantages of publishing the Merkle root to the blockchain include the ability to provide a timestamped, immutable record for verification of the snapshot.

All files in the VAST file system can now be traced back to a published Merkle root with the signature of the VAST file system owner. Also, it should be noted from FIG. 15 that the Merkle root can be made public for Bob's verification purposes, but the actual contents remain private. So, for example, ongoing existence and integrity of the database contents can be validated by Bob e.g. for security purposes, without disclosing sensitive, private, valuable or secure information e.g. military-related data or commercially valuable data.

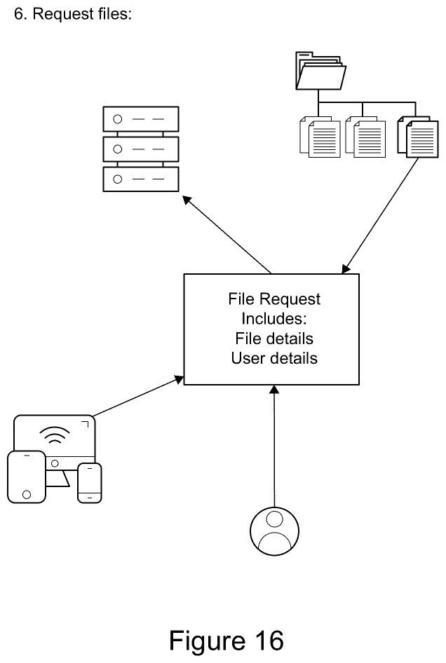

With reference to FIGS. 16 to 18, we provide an illustration of an implementation in which a file can be requested and obtained by a user in a plurality of ways. In FIG. 16, when a file is requested, the illustrated service validates the user's permission to access the information and if valid, locates it in the memory storage unit that it is stored in and serves the file to the user's device. The user may submit user account information, device specific identifiers etc. In all cases, a gating function is applied that only responds to valid requests from parties with the correct permission levels.

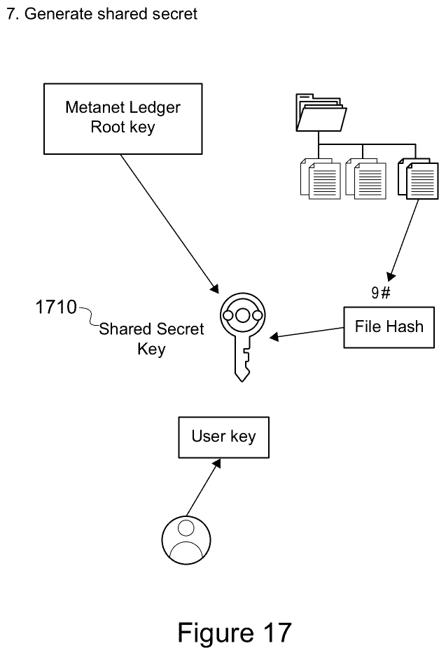

In FIG. 17, when a file is requested, the service provides the user with the hash of the file. The user and the database owner/controller (Alice) cooperate to create a secret keypair using the service's well known key (e.g. as provided in their Metanet root node), the user's account key and the hash of the file.

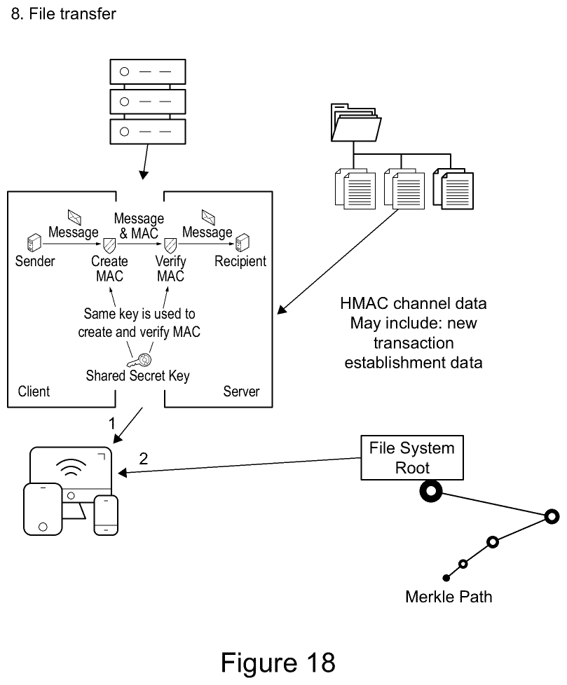

In FIG. 18, the file is delivered from Alice to Bob by providing two components:
1. The file. To transfer the file, the service creates a HMAC (hash-based authentication code) as known in the art, and the file is encrypted using the generated secret keys and transferred; and
2. The Merkle path from the file hash to the published file system's Merkle root is also transferred. This enables verification as described above.

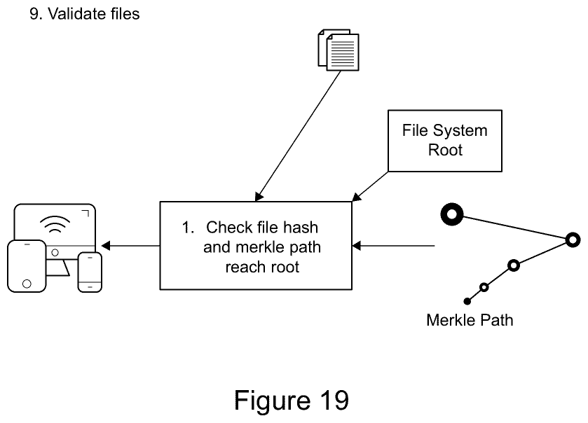

FIG. 19 illustrate the process in which the file is verified. The user (e.g. Bob) validates the file(s) using the following steps:
1. The full contents of that leaf in the Merkle tree must be transferred.
2. The receiver hashes the file
3. The hash is checked against the provided Merkle path
4. The Merkle path is checked against a Merkle root that is published on the public ledger.

If the checks produce a match, validation succeeds. If they do not, it fails. Using this process, Bob can validate that the file is exactly what was added to the file system when the entry was created.

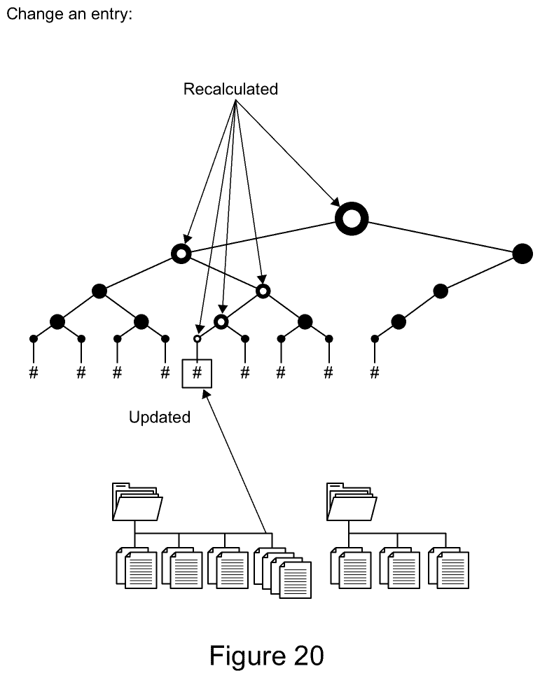

In FIG. 20, there is provided an illustration of how an entry in the VAST file system can be processed e.g. changed. Entries can be changed one or many times. Each change requires the calculation of a new set of N hashes where N is the depth of the Merkle tree. To limit the number of changes that can be executed within a block of N entries to N, a redirect can be published. This will push all changes to the active end of the Merkle tree, (i.e. the portion that is being acted upon and changed) limiting the complexity and resource costs involved in performing updates.

### Scalable Updating

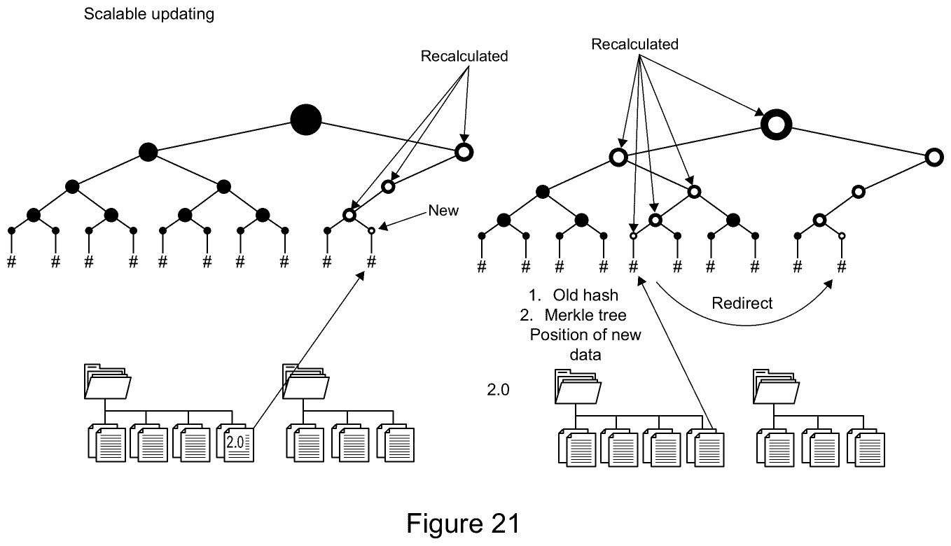

We now use the illustrative VAST file system of FIGS. 13 to 24 to show how embodiments of the disclosure can be used to implement scalable updates of information and data. With reference to FIG. 21 in particular, to scale effectively, each leaf can be limited to a single change to a new hash that represents the updated information. A leaf update can also include the hash of the previous document (i.e. the pre-update, former or and/or original version of the document).

When a file is changed, a new leaf with the new file hash and information is created. The Merkle path can be recalculated up to the top of the closest related branch to the original location.

A re-direct can then be published at the leaf location, where the previous version was registered it, and the Merkle path recalculated up to the Merkle tree root. The root can then be published.

### Sub-Trees

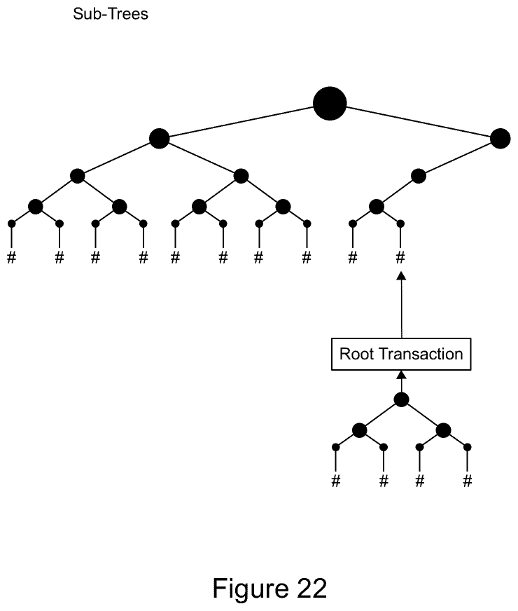

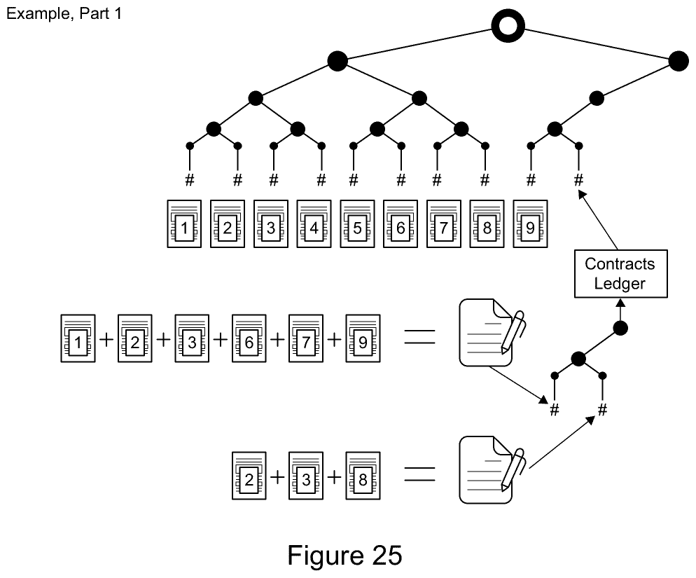

With particular reference to FIGS. 22 to 26, sub-trees can be added to implement, represent and/or function as sub-directory structures. This enables hierarchical data structures to be implemented efficiently and in a verifiable manner. In some embodiments, the sub-trees can represent separate databases in their entirety. A sub-tree can inherit the same function as the main tree, and is created via an entry in the main tree.

Advantageously, one or more sub-trees can be added which are Merkle trees of documents that have been formed into segments as per the embodiment outlined above.

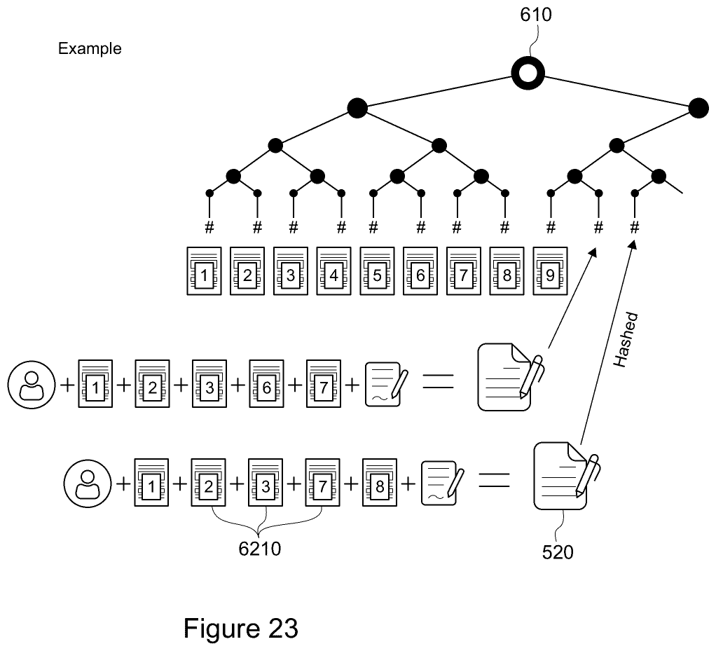

FIGS. 23 to 26 provide examples of a sub-tree being used. Consider a scenario in which an organisation creates a tree of contract clauses in a contract document as illustrated in the accompanying Figures and described above. In our example, these contract clauses reside in a sub-tree of the company's overall on-chain ledger. The first N entries are a list of contract clauses that can be used to build entire contracts. In some embodiments, this can be implemented in a business format such as EBRL, FPML or other suitable formats.

The N+1th entry is the transaction identifier (TXID) of a blockchain transaction that comprises a sub-tree (or Merkle root of the sub tree) that holds contracts generated from the upper tree, plus any relevant user data and signatures. The hash of the complete document is added to the Merkle tree and published.

Advantageously, logic code can be provided to automate the execution and use of the contract. For example, the software could contain rules that disallow contracts with clauses that come later in the Merkle tree to be used in valid contracts. This can allow the database to be updated and permission rights applied to particular versions of the document. In some embodiments, the contract may be implemented on a blockchain as a ‘smart contract’. In certain embodiments, the smart contract could be associated with a tokenised asset. This could be a non-fungible token (NFT) as known in the art.

In some embodiments, contracts can be generated from segments that hash to leaf elements on the upper tree. The whole contract is delivered via HMAC in one contiguous piece, and the user can then hash the totality of the document to check that it matches the expected hash in the contracts ledger. This way the user can be sure that they are always looking at the correct version of the contract. By way of example and as illustrated in FIG. 26, a contract using the clause in position 13 would be invalid in the sub-tree at position 10 but valid in the sub-tree in position 16.

Therefore, come embodiments may comprise the steps of providing, obtaining, processing and/or using a smart contract to automate the execution of a contract arranged substantially as disclosed in any of the embodiments provided herein.

As has been shown above, embodiments provide solutions for verifying an electronic data resource even when a subset of the data has been redacted/removed. Preferred embodiments utilise the properties of Merkle trees to provide such solutions.

Although Merkle trees are known, the disclosed embodiments different in significant and inventive ways.

### TERMINOLOGY

It should be noted that the terms ‘redaction’, ‘adaptive redaction’ and ‘sanitisation’ are used somewhat fluidly and inconsistently in the prior art. Herein, we use the term ‘redaction’ for ease of reference but with the intention of this including ‘adaptive redaction’ and ‘sanitisation’, and with the intention that it includes ‘obscuring’, masking’, ‘removing’ and or ‘replacing’ one or more selected portions of a data resource.

Also, the following terms are used herein as follows:
‘sharing’ comprises one or more of: displaying, transmitting, distributing, presenting, streaming, printing, making available, providing access to or otherwise providing from one entity to at least one further entity. An entity can be any human individual, or machine-based resource, or group thereof. Preferably, ‘sharing’ includes providing to the at least one further entity in a manner that reveals the contents of the segments in a meaningful way, such as a way that can be read, processed, executed and or understood by a human or machine, possibly for a given purpose;
‘data resource’ can include any portion of (preferably electronic or digital) data such as, but not limited to: one or a group of files, documents, videos, or other electronically/digitally provided content; the term may be used to include a single item of content, or a plurality of data items that may, collectively, be viewed as a single entity/resource; additionally, a single data resource may be owned and/or controlled by one or more data controllers;
‘data controller’ is intended to mean any entity or group of entities that has control and/or authorisation over a data resource. The data controller may be a generator or owner of the data resource or a part thereof, or may be authorised by or on behalf of such a party to have access to and/or control over access to the data resource; the data controller may comprise more than one entity or sub-entities e.g. more than one organisation, individual, or entity can share control/ownership of a data resource; in some cases, where more than one party forms the data controller, a signature threshold may apply e.g. n of m signatures or authorisations may be required for an action to be deems approved by the data controller; herein, for the purpose of convenience, we may refer to the data controller(s) as ‘Alice’;
‘obtaining’ comprises any method of coming into possession of some entity, and includes generating, calculating, selecting, or receiving from one or more sources;
The terms ‘validation’ and ‘verification’ (and correspondingly ‘validator/verifier’) may be used interchangeably herein;
“processing” includes, but is not limited to, one or more of: generating, storing, transmitting (over an electronic network), transferring control of, accessing, viewing, or modifying;
‘blockchain’ is intended to cover any form of distributed ledger, irrespective of the form of its associated implementation, network or protocol, or the type of cryptocurrency that it may be associated with, or whether it is a private or public, or utilises a proof-of-work, proof-of-stake or any other type of consensus mechanism;
“Bitcoin” as used herein is intended to include all protocols and implementations that derive or deviate from the original protocol set out by Satoshi Nakamoto in the Bitcoin whitepaper ‘Bitcoin: a peer-to-peer electronic cash system’ [2008]. The Bitcoin blockchain may be referred to herein for the sake of convenience as it is the most widely known. However, embodiments of the disclosure are not limited in this regard and other blockchain protocols and implementations fall within the scope of the present disclosure, whether they derive from the original Bitcoin protocol or not.

### ENUMERATED CLAUSES FOR ILLUSTRATED EMBODIMENTS

It will be appreciated that the above embodiments have been described by way of example only. More generally there may be provided a method, apparatus or program in accordance with any one or more of the following Statements.

Any feature provided in this section in respect of a particular clause set, embodiment or aspect is not thus limited and can be used or incorporated in respect of any one or more other clause sets, embodiments or aspects.

Embodiments of the disclosure provide computer-implemented systems and methods. Additionally or alternatively, they may provide methods and systems for one or more of: security of data; redaction of electronic data; (cryptographic) control of access to a (preferably digital) data resource or at least one part thereof; redaction of a (preferably digital) data resource; secure communication/distribution of a (preferably digital) data resource; control of selective access to a (preferably digital) data resource.

Additionally, or alternatively, embodiments of the disclosure may provide one or more of:
improved digital signature algorithms
improved smart contract solutions
improved solutions for obtaining or providing forms, templates or data resources for completion by one or more users;
   completion may comprise contribution of a signature (digital, cryptographic or otherwise formed) and/or contribution of one or more pieces of data. A redacted version of a data resource may be provided, wherein the user(s) contribute a response or input to replace, alter, modify or otherwise process the redacted portion(s). In this way, the redacted portions may function as placeholder(s) for input that is to be provided by the one or more users.

Embodiments are provided comprising systems and methods substantially as described herein and in particular with respect to the section entitled ‘Templates and forms’.

Technical benefits that flow from embodiments can include, but are not limited to: preservation or enhancement of privacy and/or anonymity, security of data, improved selective sharing of data, improved verification of the authenticity and/or integrity of a data resource.

In accordance with one form of wording, an embodiment may be described as comprising a computer-implemented method comprising:
Sharing and/or providing at least one segment of a data resource comprising a plurality of segments;
facilitating or performing verification of the data resource using a Merkle Tree comprising respective hashes of the plurality of segments as leaf nodes of the tree. Verification of the data resource may comprise validating the authenticity, ownership, origin, integrity and/or provenance-related data pertaining to the data resource.

Additionally, or alternatively, in accordance with another form of wording, an embodiment may be described as comprising a computer-implemented method comprising:
obtaining e.g. generating a Merkle Tree of a first version of a digital resource comprising a plurality of segments, wherein (leaf) nodes in the Merkle tree comprise respective hashes of the plurality of segments;
signing the root of the Merkle tree;
using the signed Merkle tree root to verify the first and/or second version of the digital resource.

The skilled person would understand that all tree structures, including Merkle trees, comprise a root. Therefore, no antecedence is required for ‘the root’ in the above definition.

The first version may be a non-redacted and/or original version of a data resource. The second version may be a redacted version of the data resource, wherein one or more portions/segments/elements of the first version have been omitted, replaced and/or altered in some way relative to their original state. The second version may be provided or obtained by selecting a sub-portion of the plurality of the segments (i.e. the plurality of segments minus at least one segment).

One or more additional data items may be included in the message that is digitally signed.

The digital signature may be generated using a key that is owned, controlled or operated by a controller/owner of the data resource.

Signing the root may comprising signing a message that comprises the root or a hash thereof.

The root may be signed by one or more controllers/owners/administrators of the data resource.

Verifying the first and/or second version of the digital resource may comprise any one or more of the ‘validation/verification’ process steps disclosed herein. It may comprise one or more of:
Checking that a key, digital signature and/or message match
checking that a calculated Merkle root matches a version provided by a data controller and/or in a signed message
accessing one or more (minimal redactable) segments/elements of the data resource
hashing at least one minimal redactable element (segment)
uses the provided Merkle path elements to calculate the root
providing or obtaining one or more Merkle paths to non-redacted resource segments (i.e. the smallest number of additional nodes in the tree required to compute the root hash, starting from a given leaf).

Additionally, or alternatively, in accordance with another form of wording, an embodiment may be described as comprising a computer-implemented method comprising:
providing or obtaining the root of a Merkle tree that is representative of at least one data resource, wherein each segment of the at least one data resource is provided as a respective leaf of the Merkle tree;
using a signed message comprising the root of the Merkle tree to facilitate or perform validation of a redacted version of the at least one data resource.

Additionally, or alternatively, in accordance with another form of wording, an embodiment may be described as comprising a computer-implemented method comprising:

providing a computer-implemented arrangement for validating a redacted subset of portions of a data resource; and/or
validating or facilitating validation of a redacted subset of portions of a data resource.

This method may be combined with any one or more of the features/steps disclosed herein. ‘portions’may be replaced with ‘segments’.

Additionally, or alternatively, in accordance with another form of wording, an embodiment may be described as comprising a computer-implemented method comprising the step of providing from or on behalf of a sender (e.g. data controller) to a recipient (e.g. data verifier):
a redacted version of a data resource comprising a plurality of segments, wherein the data resource is redacted relative to an original (first/initial) state of the data resource in that at least one of the plurality of segments has been redacted;
a (respective) hash of the or each redacted segment; and/or
a Merkle Tree of the original version of the data resource, Merkle tree comprising:
   i) (leaf) nodes comprising respective hashes of the plurality of segments in the original version of the data resource, and/or
   ii) a root that has been signed by, or on behalf of, the data controller.

Redacting the at least one segment may comprise omitting, replacing or altering it from/in the redacted version.

Additionally, or alternatively, in accordance with another form of wording, an embodiment may be described as comprising a computer-implemented method comprising the step of receiving, by a recipient (e.g. data verifier) and from a sender (e.g. data controller or a party on behalf of a data controller):

a redacted version of data resource comprising a plurality of segments, wherein the data resource is redacted relative to an original (first/initial) state of the data resource in that at least one of the plurality of segments has been redacted;
a (respective) hash of the or each redacted segment; and/or
a Merkle Tree of the original version of the data resource, Merkle tree comprising:
   i) (leaf) nodes comprising respective hashes of the plurality of segments in the original version of the data resource, and/or
   ii) a root that has been signed by, or on behalf of, the data controller.

The method may also comprise one or more of:
using, by or on behalf of the recipient, the redacted version of the data resource and the hash or hashes for the at least one redacted segment, to construct a new instance of the Merkle tree of the original version of the data resource;
comparing the root of the new instance of the Merkle tree of the original version of the data resource with the root of the Merkle tree provided by the sender;
verifying the digital signature of the root of the Merkle tree provided by the sender. verifying the digital signature of the root of the Merkle tree provided by the sender may comprise one or more steps to check whether the signature of the provided Merkle root has been generated using a cryptographic key known to be associated with the data controller or derived from a cryptographic key known to be associated with the data controller.

The step of constructing the new instance of the Merkle tree of the original version of the data resource may be performed by combining the redacted version of the data resource with the hash of the or each redacted segment. The Merkle tree may be constructed using the known technique of hashing pairs of hashes to derive the root of the overall data resource.

This step may comprise inserting the or each hash of the redacted segment(s) into the redacted data resource, and/or replacing the redacted segments of the redacted version of the data resource with the respective hash of the or each redacted segment. In other words, the redacted segment(s) may be replaced with their respective hashes to enable the new instance of the Merkle tree to be constructed.

The redacted version of the data resource may be deemed as verified and/or legitimate if:
the digital signature of the signed Merkle root is confirmed or verified as having been generated using a cryptographic key known to be associated with the data controller or derived from a cryptographic key known to be associated with the data controller; and/or
the root of the new instance of the Merkle tree (constructed by the recipient) matches the signed root of the Merkle tree (provided by the sender).

Additionally, or alternatively, in accordance with another form of wording, an embodiment may be described as a method of verifying a redacted version of a data resource, comprising obtaining, from a source:
a signed root of a Merkle tree that represents an original version of the data resource comprising a plurality of segments, wherein each leaf in the tree comprises a hash of a respective segment, and the signed root comprises or is associated with a digital signature associated with an authorised entity of the data resource;
a hash of at least one segment in the plurality of segments.

Such a method may further comprise one or more of the steps:
obtaining, from the source, a Merkle path and/or a redacted version of the data resource;
verifying the redacted version of the data resource;
obtaining an indication or identification of one or more segments of the plurality of segments that have been redacted.

Additionally, or alternatively, in accordance with another form of wording, an embodiment may be described as a computer-implemented method comprising the steps:
providing or obtaining:
   i) a Merkle tree that is representative of at least one data resource, wherein each of a plurality of segments of the at least one data resource is provided as a respective leaf of the Merkle tree, and the Merkle tree comprises a signed Merkle root that is signed by, or on behalf of, at least one authorised or controlling entity
   ii)) a redacted version of the at least one data resource, the redacted version comprising a subset of the plurality of segments; and
   iii) the hash of each segment in the subset of the plurality of segments.

The providing and/or obtaining may be performed by a node on a computer network. The providing may be performed by at least one (first) sending node/computing resource and the obtaining may be performed by at least one (second) receiving node/computing resource.

### Clause Set 1

Clause 1.1. A computer-implemented method comprising the steps:
providing or obtaining the root of a Merkle tree that is representative of at least one data resource, wherein each of a plurality of segments of the at least one data resource is provided as a respective leaf of the Merkle tree;
performing or facilitating validation of a redacted version of the at least one data resource using a signed version of the Merkle root.

Clause 1.2. A method according to clause 1, wherein:
the Merkle root is signed by, or on behalf of, at least one authorised or controlling entity; and/or
the redacted version of the at least one data resource comprises a subset of the plurality of segments.

Clause 1.3. A method according to clause 2, and comprising one or more of:
selecting specifying or otherwise defining the plurality and/or subset of the plurality of segments of the at least one data resource;
selecting at least one segment for redaction from the data resource to obtain the sub-set of the plurality of segments.

Clause 1.4. A method according to clause 2 or 3, and comprising the step of providing, to at least one recipient, one or more of:
i) the redacted version of the at least one data resource;
ii) a digitally signed message
ii) a digitally signed copy of the Merkle root;
iii) a Merkle proof derived from the Merkle tree;
iv) a hash of at least one of the plurality of segments of the data resource;
v) additional data.

Clause 1.5 A method according to any preceding clause, wherein:
the redacted version of the at least one data resource comprises or provides a template, form or other resource for completion or input by one or more users.

Clause 1.6 A method according to any preceding clause, wherein:
i) the data resource comprises a contract; and/or
ii) a computer program is provided in association with the at least one data resource, and the computer program is operative to control or influence use of the data resource; and/or
iii) at least one segment of the at least one data resource comprises or functions as a watermark, version identifier, authentication code, security mechanism that is arranged to enable verification of the authenticity, integrity, provenance or legitimacy of the data resource.

Clause 1.7. A method according to any preceding clause, and comprising one or more of:
hashing one some or each of the segments in the plurality of segments;
using the plurality of segments to obtain the Merkle tree,
performing or facilitating the validation of the redacted version of the at least one data resource comprises one or more of:
   a) performing a comparison operation on or using one or more of: an obtained cryptographic key, a digital signature and/or message, to see if there is a match with a corresponding calculated cryptographic key, a digital signature and/or message;
   b) checking whether an obtained Merkle root matches a calculated Merkle root;
   c) accessing or otherwise processing at least one segment of the plurality of segments;
   d) hashing at least one segment in the plurality of segments;
   e) using one or more Merkle path components to calculate the Merkle root.

Clause 1.8. A method according to any preceding claim, and further comprising step of
providing, by a sender to at least one recipient, the redacted version of the at least one data resource;
optionally wherein the step of providing the redacted version comprises generating a shared secret between the sender and the at least one recipient.

Clause 1.9. A method according to any preceding clause, and comprising the step of
providing a computer-based system to output the redacted version of the at least one data resource;
optionally wherein the system comprises one or more of:
   a cloud-based service or executable resource;
   an internet-based service or resource;
   a software application arranged for execution on a mobile, portable or desktop-based system;
   a digital wallet;
   a browser;
   a word processing application or PDF/document viewer;
   software for providing audio and/or video output;
   an electronic, computer-based storage resource;
   software for scanning, copying or capturing an image of a resource;
   software for generating an electronic signature and/or binding the electronic signature to a portion of data;
   software and/or hardware for performing or facilitating a financial transaction and/or exchange of assets;
   a cryptocurrency platform.

Clause 1.10. A method of verifying a redacted document, comprising the steps:
obtaining, from a source:
   a root of a Merkle tree that represents a data resource comprising a plurality of segments, wherein each leaf in the tree comprises a hash of a respective segment;
   a hash of at least one segment in the plurality of segments;
   a Merkle path;
   a digital signature associated with an authorised entity of the at least one data resource.

Clause 1.11 A computer system comprising:
memory comprising one or more memory units; and
processing apparatus comprising one or more processing units, wherein the memory stores or executes code arranged to run on the processing apparatus, the code being configured so as when on the processing apparatus to perform the method of 20 any of clauses 1 to 10.

Clause 1.12. A computer system according to clause 1.11, wherein the system further comprises one or more of:
a storage or file system, optionally wherein the file system is or comprises a VAST file system;
database;
a component operative to interact with a blockchain network and/or a blockchain ledger.

Clause 1.13. A computer program embodied on computer-readable storage and configured so as, when run on one or more processors, to perform the method of any of clauses 1.1 to 1.10.

### Clause Set 2

### Clause 2.1

In accordance with illustrative clause set 2, there may be provided a method of:
obtaining e.g. generating a Merkle Tree of a first version of a digital resource comprising a plurality of segments, wherein one some or all (leaf) nodes in the Merkle tree comprise respective hashes of the plurality of segments;
signing the root of the Merkle tree;
using the signed Merkle tree root to verify the first and/or second version of the digital resource.

The second version may be referred to as a redacted version of the data resource. It may comprises at least one fewer segments that the first version.

Clause 2.2: a method according to clause 2.1, and further comprising one or more of:
i) using a digitally signed the Merkle Tree to verify the authenticity and/or integrity of the first or second version of the digital resource;
ii) providing, by a source to a receiver, a second version of the digital resource that comprises a sub-set of the plurality of segments.

The term ‘sub-set’ may mean ‘one or more fewer’ than the original set/plurality.

Clause 2.3. A method according to clause 2.1 or 2.2, wherein:
verifying the authenticity and/or integrity of the first or second version of the digital resource comprises checking a digital signature that has been applied to (a message comprising) at least the root of the Merkle tree and/or one or more of the hashes of the plurality of segments.

Clause 2.4. A method according to any preceding clause in clause set 2, and comprising:
ii) hashing the plurality of segments to provide the respective nodes of the Merkle Tree;
ii) selecting a sub-set of the plurality of segments.

Any method of any of clause sets 1 or 2, wherein and/or comprising:
the first (i.e. no-redacted/original) version of the data resource comprises N segments
the plurality of N segments is hashed to provide respective (leaf) nodes in the Merkle tree;
she Merkle tree has a root that is signed by an authorised party e.g. by or on behalf of at least one data controller/owner
signing is performed via any electronic/cryptographic means, optionally using a key that is generated using a common secret;
The step of providing the Merkle Tree comprises hashing each of the N segments to provide respective (leaf) nodes in the Merkle Tree
Viewing or otherwise presenting the redacted version of the data i.e. outputting the plurality of segments minus x selected, redacted segments, where x=>=1
The (n-x) segments that are shared comprise pre-images of the hashes of respective (n-x) segments.
the step of sharing (possibly from same entity e.g. Alice and/or possibly to the same at least one further entity e.g. Bob) replacement segment(s)s for the redacted segment(s)
Selecting x segments to be excluded from the sharing step
Verifying comprises hashing some or preferably all of the n segments and comparing each hash against a respective node in the Merkle Tree ‘Sharing can comprise any means of making available. This can include but is not limited to send, transmitting, displaying, outputting or providing access to e.g. by download by a user.

### Clause Set 3

Clause 3.1 A computer-implemented method comprising:
inserting or otherwise providing at least one
identifier/code/watermark/timestamp/reference into at least one segment in a plurality of segments of a data resource.

The plurality of segments may then be processed in accordance with any embodiment disclosed wherein. For example, the method may comprise one or more of:
Defining, selecting, calculating or otherwise obtaining the plurality of segments of the data resource;
Hashing the plurality of segments
Obtaining a Merkle tree that represents the data resource, wherein the hashes of the segments provide the leaves of the tree
Signing the root of the Merkle tree (and/or a message comprising the root)
Selecting one or more segments for redaction, meaning that they are designated as ‘not for sharing’/omitted from the sharing operation(s)
Sharing, with at least one receiver, one or more non-redacted segments of the plurality of segments (i.e. segments that have been designated as ‘permitted or allowed for sharing’)
Sharing with the at least one receiver, one or more of: a public key associated with the private key that was used to sign the root, the signed Merkle root and the Merkle paths/hashes to enable verification of the non-redacted segments by calculation by the at least one receiver of one or more Merkle proof(s), comparing the calculated root with the obtained/shared root, and using the public key to check that the signature and Merkle root and signature calculated by the receiver(s) matches the Merkle root and signature obtained from the sharer/sender(s).

The code, identifier and/or watermark may be inserted into one or more redacted and/or a non-redacted segments. The code, identifier and/or watermark may comprise data for uniquely attesting to the authenticity, source, version, ownership of the data resource, or be indicative of or comprise other data.

According to another aspect disclosed herein, there may be provided a system comprising computer equipment as claimed or described herein, and/or capable of executing any method disclosed herein.

### EXAMPLE SYSTEM OVERVIEW

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

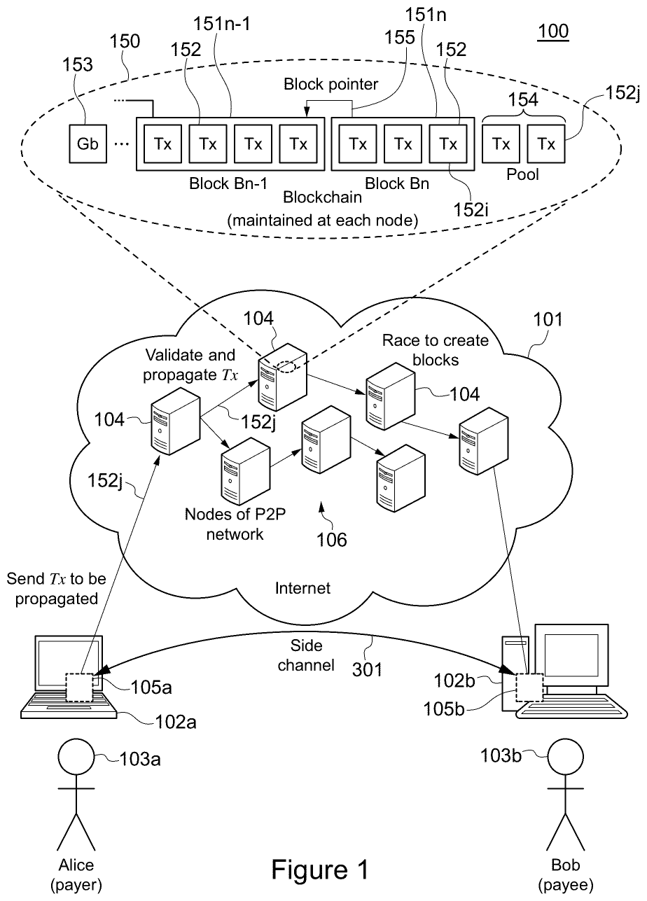

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more blockchain nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### UTXO-BASED MODEL

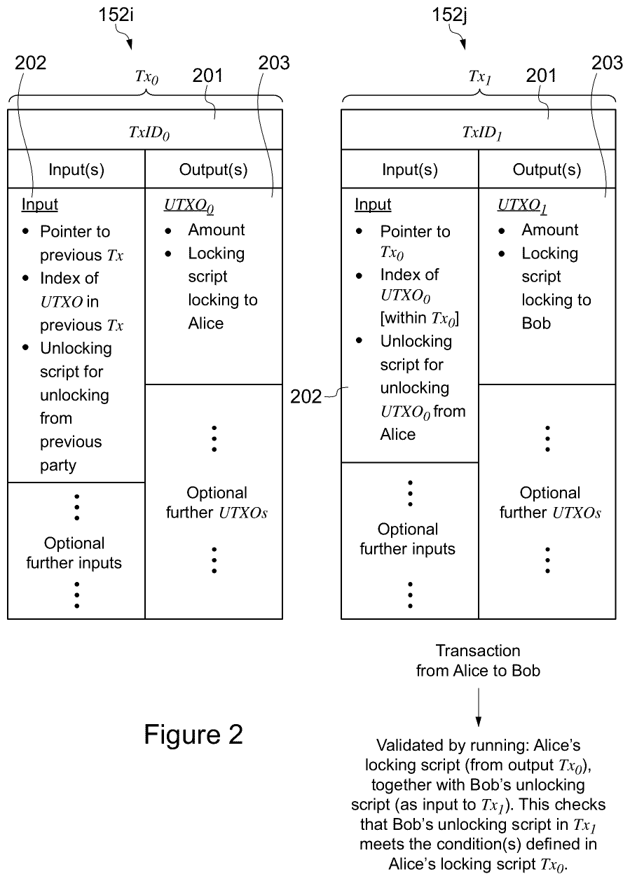

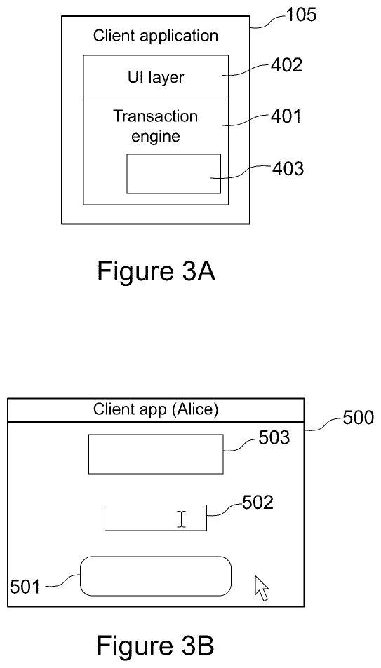

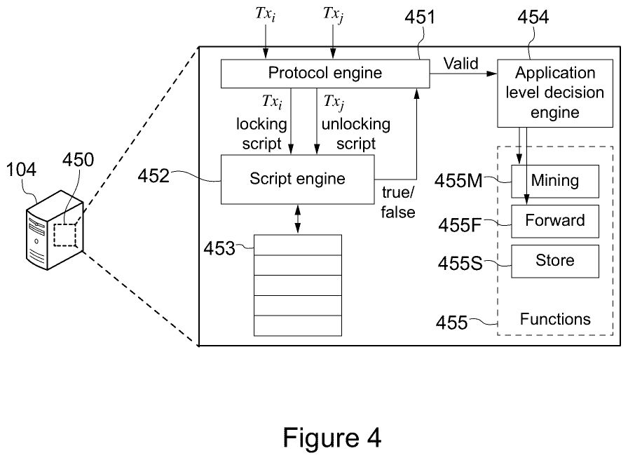

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “TX₁” . It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig PA of Alice in order for UTXO₀ to be redeemed (strictly, in order for a subsequent transaction attempting to redeem UTXO₀ to be valid). [Checksig P_{A}] contains a representation (i.e. a hash) of the public key PAfrom a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP _ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### FURTHER REMARKS

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However, proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

Any reference in this specification and accompanying Figures to “Bitcoin”, “cryptocurrency” or a particular cryptocurrency protocol may be replaced with the term “blockchain” or “blockchain network” or “blockchain protocol” as appropriate to the specific context where these terms are used.

### Disclaimer

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A computer-implemented method comprising the steps:
providing or obtaining:
a Merkle tree that is representative of at least one data resource, wherein each of a plurality of segments of the at least one data resource is provided as a respective leaf of the Merkle tree;
a signed Merkle root for the Merkle tree, wherein the Merkle root is signed by, or on behalf of, at least one authorised or controlling entity;
a redacted version of the at least one data resource, the redacted version comprising a subset of the plurality of segments; and
a hash of each segment in the subset of the plurality of segments.

2. The method of claim 1, wherein the method further comprises the step of:
using the signed Merkle root to perform or facilitate validation of the redacted version of the at least one data resource; and/or
using the hash of each segment in the subset of the plurality of segments and the redacted version of the at least one data resource to construct an original version of the Merkle tree of the at least one data resource.

3. The method of claim 2, and comprising one or more of:
selecting specifying or otherwise defining the plurality and/or subset of the plurality of segments of the at least one data resource;
selecting at least one segment for redaction from the data resource to obtain the subset of the plurality of segments.

4. The method of claim and comprising the step of providing, to at least one recipient, one or more of:
the redacted version of the at least one data resource;
a digitally signed message;
a digitally signed copy of the Merkle root;
a Merkle proof derived from the Merkle tree;
a hash of at least one of the plurality of segments of the data resource;
additional data.

5. The method of claim 1, wherein:
the redacted version of the at least one data resource comprises or provides a template, form or other resource for completion or input by one or more users.

6. The method of-A preceding-claim 1, wherein:
the data resource comprises a contract; and/or
a computer program is provided in association with the at least one data resource, and the computer program is operative to control or influence use of the data resource; and/or
at least one segment of the at least one data resource comprises or functions as a watermark, version identifier, authentication code, security mechanism that is arranged to enable verification of the authenticity, integrity, provenance or legitimacy of the data resource.

7. The method of claim 1, and comprising one or more of:
hashing one some or each of the segments in the plurality of segments;
using the plurality of segments to obtain the Merkle tree,
performing or facilitating the validation of the redacted version of the at least one data resource comprises one or more of:
performing a comparison operation on or using one or more of: an obtained cryptographic key, a digital signature and/or message, to see if there is a match with a corresponding calculated cryptographic key, a digital signature and/or message;
checking whether an obtained Merkle root matches a calculated Merkle root;
accessing or otherwise processing at least one segment of the plurality of segments;
hashing at least one segment in the plurality of segments;
using one or more Merkle path components to calculate the Merkle root.

8. The method of claim 1, and further comprising step of providing, by a sender to at least one recipient, the redacted version of the at least one data resource.

9. The method of claim 1, and comprising the step of providing a computer-based system to output the redacted version of the at least one data resource.

10. A method of verifying a redacted version of a data resource, comprising obtaining, from a source:
a signed root of a Merkle tree that represents an original version of the data resource comprising a plurality of segments, wherein each leaf in the tree comprises a hash of a respective segment, and the signed root comprises or is associated with a digital signature associated with an authorised entity of the data resource;
a hash of at least one segment in the plurality of segments.

11. The method of claim 10, and further comprising one or more of the steps:
obtaining, from the source, a Merkle path and/or a redacted version of the data resource;
verifying the redacted version of the data resource;
obtaining an indication or identification of one or more segments of the plurality of segments that have been redacted.

12. The method of claim 1, and further comprising the step of:
providing at least one code, identifier, version data, key, timestamp and/or watermark into at least one segment in the plurality of segments of the data resource.

13-15. (canceled)

16. A computer program embodied on non-transitory computer-readable storage media and configured so as, when run on one or more processors, the one or more processors perform a method of providing or obtaining:
a Merkle tree that is representative of at least one data resource, wherein each of a plurality of segments of the at least one data resource is provided as a respective leaf of the Merkle tree;
a signed Merkle root for the Merkle tree, wherein the Merkle root is signed by, or on behalf of, at least one authorised or controlling entity;
a redacted version of the at least one data resource, the redacted version comprising a subset of the plurality of segments; and
a hash of each segment in the subset of the plurality of segments.

17. The method of claim 8, wherein the step of providing the redacted version comprises generating a shared secret between the sender and the at least one recipient.

18. The method of claim 9, wherein the system comprises one or more of:
a cloud-based service or executable resource;
an internet-based service or resource;
a software application arranged for execution on a mobile, portable or desktop-based system;
a digital wallet;
a browser;
a word processing application or PDF/document viewer;
software for providing audio and/or video output;
an electronic, computer-based storage resource;
software for scanning, copying or capturing an image of a resource;
software for generating an electronic signature and/or binding the electronic signature to a portion of data;
software and/or hardware for performing or facilitating a financial transaction and/or exchange of assets;
a cryptocurrency platform.
